(19) United States
(12) Patent Application Publication
(10) Pub. No.: US 2026/0296798 A1
(43) Pub. Date: Oct. 1, 2026

(54) ALIGNER DEVICE FOR REDIRECTING ITEMS IN CONVEYANCE

(71) Applicant: Federal Express Corporation, Memphis, TN (US)

(72) Inventor: Travis Henderson, Pittsburgh, PA (US)

(21) Appl. No.: 19/093,999

(22) Filed: Mar. 28, 2025

(51) Int. Cl. B65G 47/30; B65G 13/00; B65G 37/00

(52) U.S. Cl. CPC B65G 47/30; B65G 13/00; B65G 37/00; B65G 2811/0621

(57) ABSTRACT

Various implementations relate to an aligner device for redirecting items in conveyance. The aligner device includes a bracket and an aligner arm. The bracket is configured to be coupled with a conveyor. The bracket defines multiple slots that are oriented at different angles. The aligner arm includes a coupling portion and a redirecting portion. The coupling portion is configured to be inserted into a slot of the multiple slots to couple the aligner arm with the bracket. The redirecting portion extends from the coupling portion and is configured to redirect items in conveyance that engage with the redirecting portion.

### TECHNICAL FIELD

The present specification relates to aligner devices, and specifically to aligner devices for redirecting items in conveyance.

### BACKGROUND

In various industrial applications, it is often necessary to transfer items from one conveyor to another to facilitate continuous and efficient material handling. This process involves placing conveyors adjacent to each other in a manner that allows items to transition from one conveyor to another. In some applications, mobile loading docks have conveyors fixed within them. Daily operations may require these mobile loading docks to be moved such that their conveyors are added to the existing path of permanent, fixed conveyors in a separate area. This configuration may only be required during specific periods and therefore must be assembled and disassembled regularly. Tractors may be used to connect and disconnect the mobile loading docks.

### SUMMARY

In general, the present disclosure relates to aligner devices, and specifically to aligner devices for redirecting items in conveyance.

Some aspects of the subject matter described in this specification can be embodied in a device that includes a bracket and an aligner arm. The bracket is configured to couple with a conveyor. The bracket defines multiple slots that are oriented at different angles. The aligner arm includes a coupling portion and a redirecting portion. The coupling portion is configured to be inserted into a slot of the multiple slots to couple the aligner arm with the bracket. The redirecting portion extends from the coupling portion and is configured to redirect items in conveyance that engage with the redirecting portion.

In some implementations, the redirecting portion of the aligner arm includes a first planar surface providing a contact surface area configured to engage with items in a conveyance pathway that intersects with the first planar surface. The bracket includes a second planar surface at least partially defining the multiple slots. When the aligner arm is coupled with the bracket via the coupling portion, the first planar surface is orthogonal to the second planar surface.

In some implementations, the redirecting portion of the aligner arm includes a first planar surface providing a contact surface area configured to engage with items in a conveyance pathway that intersects with the first planar surface. The coupling portion of the aligner arm includes a second planar surface oriented at a nonzero angle to the first planar surface.

In some implementations, the aligner arm further includes an interconnecting portion that extends between the coupling portion and the redirecting portion. The interconnecting portion is shaped to orient the first planar surface of the redirecting portion at the nonzero angle relative to the second planar surface of the coupling portion.

In some implementations, the interconnecting portion comprises a curved surface that interconnects the first planar surface of the redirecting portion with the second planar surface of the coupling portion.

In some implementations, the first planar surface of the redirecting portion is stationary relative to the second planar surface of the coupling portion.

In some implementations, the multiple slots defined by the bracket include a first slot and a second slot. The first slot is configured to couple the bracket with the coupling portion of the aligner arm so as to orient the redirecting portion of the aligner arm parallel to a direction of conveyance. The second slot is configured to couple the bracket with the coupling portion of the aligner arm so as to orient the redirecting portion of the aligner arm at a first nonzero angle relative to the direction of conveyance.

In some implementations, the multiple slots defined by the bracket further include a third slot configured to couple the bracket with the coupling portion of the aligner arm so as to orient the redirecting portion of the aligner arm at a second nonzero angle, relative to the direction of conveyance, different than the first nonzero angle.

In some implementations, the bracket and the aligner arm are formed of one or more inelastic materials.

In some implementations, the redirecting portion of the aligner arm includes a first planar surface providing a contact surface area configured to engage with items in a conveyance pathway that intersects with the first surface. The coupling portion of the aligner arm includes a second planar surface oriented at a nonzero angle to the first planar surface. The second planar surface is stationary relative to the first planar surface. The coupling portion defines an aperture configured to receive a fastener such that the fastener contributes to restricting one or more degrees of freedom of the aligner arm while the coupling portion is coupled with the bracket. The bracket includes a third planar surface at least partially defining the multiple slots. When the aligner arm is coupled with the bracket via the coupling portion, the first planar surface of the redirecting portion is orthogonal to the third planar surface of the bracket. The aligner arm further includes an interconnecting portion that extends between the coupling portion and the redirecting portion. The interconnecting portion includes a curved surface configured to orient the first planar surface of the redirecting portion at the nonzero angle relative to the second planar surface of the coupling portion.

The multiple slots defined by the bracket include a first set of slots located proximate a first end of the bracket. The first set of slots include a first slot, a second slot, and a third slot. The first slot is configured to couple the bracket with the coupling portion of the aligner arm so as to orient the redirecting portion of the aligner arm parallel to a direction of conveyance. The second slot is configured to couple the bracket with the coupling portion of the aligner arm so as to orient the redirecting portion of the aligner arm at a first nonzero angle relative to the direction of conveyance. The third slot is configured to couple the bracket with the coupling portion of the aligner arm so as to orient the redirecting portion of the aligner arm at a second nonzero angle, relative to the direction of conveyance, different than the first nonzero angle. The first slot, the second slot, and the third slot share a common vertex.

The bracket further defines a second set of slots located proximate a second end of the bracket. Each of the second set of slots is oriented at a respectively different angle. A first section of the bracket defines the first set of slots and the second set of slots. The first section includes a first upper surface. A second section of the bracket defines additional slots configured to couple the bracket with a conveyor frame. The additional slots are oriented at a same angle relative to one another. The second section includes a second upper surface that is at least one of (i) parallel to the first upper surface or (ii) a same surface as the first upper surface.

The bracket further includes one or more flanges including at least one surface configured to engage a side surface of the conveyor frame that extends downward, toward a floor supporting the conveyor, from an upper surface of the conveyor frame. The bracket has a longest dimension along an axis that is parallel to a direction of conveyance. The bracket has mirror symmetry about a plane that is orthogonal to the axis and that bisects the longest dimension. The bracket extends, in the longest dimension, from the first end to the second end.

Some aspects of the subject matter described in this specification can be embodied in a system that includes a conveyor, a bracket, and an aligner arm. The bracket is coupled with the conveyor. The bracket defines multiple slots that are oriented at different angles. The aligner arm includes a coupling portion and a redirecting portion. The coupling portion is inserted into a slot of the multiple slots so as to couple the aligner arm with the bracket. The redirecting portion extends from the coupling portion. The redirecting portion is configured to redirect items in conveyance that engage with the redirecting portion.

In some implementations, the conveyor includes a conveyor frame. The conveyor frame includes a mounting surface that is parallel to a direction of conveyance and that defines holes. A first section of the bracket defines the multiple slots. A second section of the bracket defines additional slots. One or more of the additional slots are in sufficient alignment with one or more of the holes defined by the mounting surface of the conveyor frame to receive one or more fasteners that couple the bracket with the conveyor.

In some implementations, the first section of the bracket defining the multiple slots includes a first upper surface. A second section of the bracket defining the additional slots includes a second upper surface that is parallel to the first upper surface.

In some implementations, a same surface of the bracket defines the multiple slots and the additional slots.

In some implementations, the additional slots are oriented at a same angle relative to one another.

In some implementations, the additional slots are closer to the conveyor than the multiple slots.

In some implementations, when viewed in plan, the second section at least partially overlaps with the conveyor and the first section does not overlap with the conveyor.

In some implementations, the mounting surface is an upper surface of the conveyor frame. The conveyor frame further comprises a side surface extending downward from the upper surface toward a floor supporting the conveyor. The bracket further comprises a flange comprising at least one surface that engages the side surface of the conveyor frame.

In some implementations, the multiple slots share a common vertex.

In some implementations, the bracket has a longest dimension along an axis that is parallel to a direction of conveyance, and the bracket has mirror symmetry about a plane that is orthogonal to the axis and that bisects the longest dimension.

In some implementations, the bracket extends, in the longest dimension, from a first end to a second end. The multiple slots include a first set of slots located proximate the first end. The bracket further defines a second set of slots located proximate the second end. Each of the second set of slots is oriented at a respectively different angle.

In some implementations, when the coupling portion of the aligner arm is inserted into any one of the first set of slots, the redirecting portion of the aligner arm extends from the coupling portion toward a first direction of conveyance. When the coupling portion is inserted into any one of the second set of slots, the redirecting portion of the aligner arm extends from the coupling portion toward a second direction of conveyance that is opposite the first direction of conveyance.

In some implementations, the first set of slots share a first common vertex from which they fan out to form the different angles. The first common vertex is the closest portion of the first set of slots to the first end. The second set of slots share a second common vertex from which they fan out to form the different angles. The second common vertex is the closest portion of the second set of slots to the second end.

Some aspects of the subject matter described in this specification include a method that includes: coupling a bracket of an aligner device with a conveyor, the bracket defining multiple slots that are oriented at different angles; and inserting a coupling portion of an aligner arm of the aligner device into a slot of the multiple slots of the bracket to couple the aligner arm with the bracket. The aligner arm includes a redirecting portion that extends from the coupling portion so as to redirect items in conveyance that engage with the redirecting portion.

In some implementations, the bracket defines additional slots configured to mount the bracket to a frame of the conveyor. Coupling the bracket with the conveyor further includes: aligning one or more of the additional slots with one or more holes defined by the frame; and inserting one or more fasteners through at least a portion of the one or more of the additional slots and the one or more holes that are aligned to attach the bracket to the frame.

In some implementations, the method further includes selecting the slot, from among the multiple slots, into which the coupling portion of the aligner arm is to be inserted. The selecting is based at least in part on a degree of misalignment between the conveyor and a subsequent conveyor positioned to receive at least a portion of the items in conveyance.

In some implementations, the coupling portion of the aligner arm defines an aperture configured to receive a fastener. The method further includes inserting the fastener into the aperture. A surface of the fastener provides compressive contact with the aperture to keep the aligner arm in a fixed position regardless of a direction of impact on the aligner arm by external forces.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 shows a perspective view and a schematic top view of an example conveyance system that includes an aligner device for redirecting items in conveyance, in accordance with some implementations.

FIGS. 2A-2B are views of another example conveyance system that includes one or more aligner devices used in a mobile loading dock environment, in accordance with some implementations. FIG. 2A shows a schematic top view of the conveyance system. FIG. 2B shows a perspective view of an example interior portion of the mobile loading dock.

FIGS. 3A-3B are perspective views illustrating example aligner arm positions of an aligner device installed on a conveyor, in accordance with some implementations. FIG. 3A shows the aligner device with its aligner arm in a first position (e.g., a nonuse position). FIG. 3B shows the aligner device with its aligner arm in a second position (e.g., an in-use position).

FIGS. 4A-4H are views of an example aligner device for redirecting items in conveyance, in accordance with some implementations. FIG. 4A shows a perspective view of the aligner device. FIG. 4B shows a top view of a bracket of the aligner device. FIG. 4C shows a perspective view of the bracket. FIG. 4D shows a front view of the bracket. FIG. 4E shows a side view of the bracket. FIG. 4F shows a perspective view of an aligner arm of the aligner device. FIG. 4G shows a top view of the aligner arm. FIG. 4H shows a front view of the aligner arm.

FIG. 5 is a top view of an example conveyance system that includes an aligner device for redirecting items in conveyance, in accordance with some implementations.

FIG. 6 is a flow chart illustrating an example method of installing an aligner device, in accordance with some implementations.

FIG. 7 is a flow chart illustrating an example method of manufacturing an aligner device, in accordance with some implementations.

FIGS. 8A-8C are views of another example aligner device for redirecting items in conveyance, in accordance with some implementations. FIG. 8A shows a front view of the aligner device. FIG. 8B shows a top view of the aligner device. FIG. 8C shows a detailed perspective view of a portion of the aligner device.

### DETAILED DESCRIPTION

Various implementations relate to an aligner device for redirecting items in conveyance.

In some applications, conveyor positions are operation-dependent – conveyors must be moved in/out of different configurations to suit variations in application throughout the day/week/month/etc.

The processes for repositioning conveyors may require human intervention, either directly or indirectly, but this introduces a margin for error in final conveyor system layout. A misalignment may impact conveyor system function through unsuccessful conveyance transition between adjacent conveyor ends. Conveyance may be blocked by downstream equipment or inadvertently discharged from the conveyor system entirely. To mitigate these breaks in a contiguous conveyance path, manual intervention is required which increases labor/inefficiency and may reduce safety. These manual interventions may include touch/shift/lift of all items in conveyance as a means of forcing them to a nonlinear conveyor next in sequence.

According to various implementations, the aligner device described in this disclosure fastens to the outside edge frames of conveyors, and merges conveyance pathways in nonlinear conveyance systems, such as those with misaligned conveyance pathways. The force of conveyance downstream pushes items against the aligner device, which is rigidly constrained during use. In some implementations, the aligner device is made from high-strength, inelastic material. The aligner redirects the conveyance path when items are drawn across the surface of the aligner arm. The aligner device forces items into the path of the subsequent conveyor downstream. The aligner device is adjustable for various angles depending on misalignment severity and conveyor widths. The aligner device includes an aligner bracket rigidly fixed to the conveyor framing, and a removable/adjustable aligner arm. The aligner arm overlaps the upstream conveyor to force-divert conveyed items to a new pathway that will successfully transition the items to the next conveyor without need for manual intervention. The adjustability of the aligner device suits variations in severity of misalignment. The aligner device can be symmetrically installed to compensate for misalignments in either direction relative to the next conveyor in series.

Some applications relate to mobile loading docks with conveyors fixed within them. Daily operations may require these mobile loading docks to be moved such that their conveyors are added to the existing path of permanent, fixed conveyors in a separate area. This configuration may only be required during specific periods and therefore must be assembled and disassembled regularly. The process of using tractors to connect and disconnect the mobile dock results in some amount of misalignment between mobile dock conveyors and permanently fixed conveyors next in series. Additionally, sequential conveyors in a system may have different widths, requiring a means of conveyance alignment regardless of whether the centerlines are nonlinear.

Additional applications include material handling systems where conveyance pathways require realignment, without manual intervention.

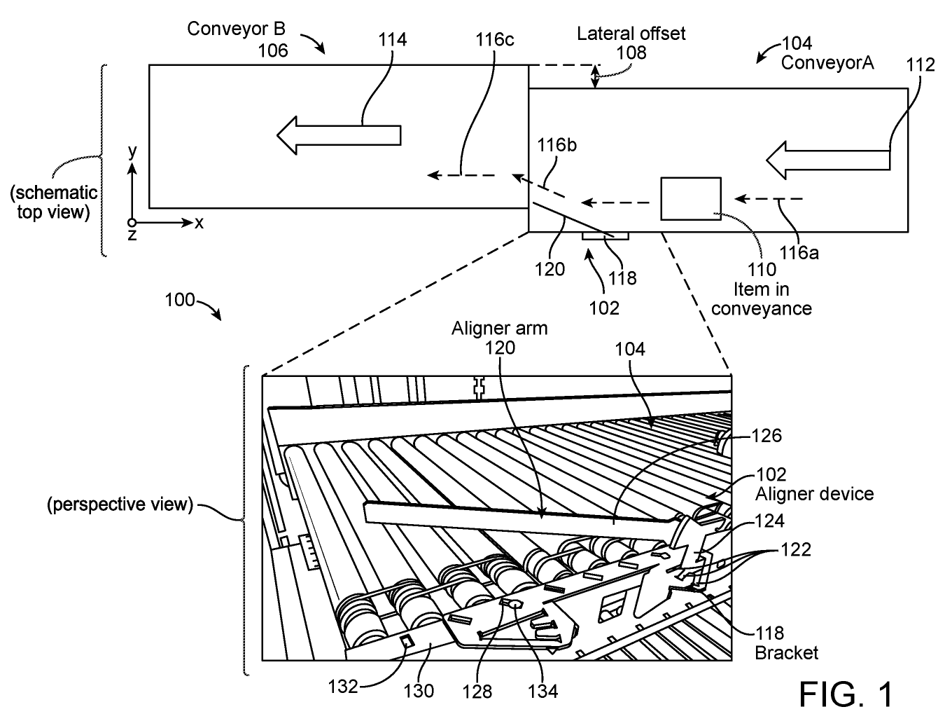

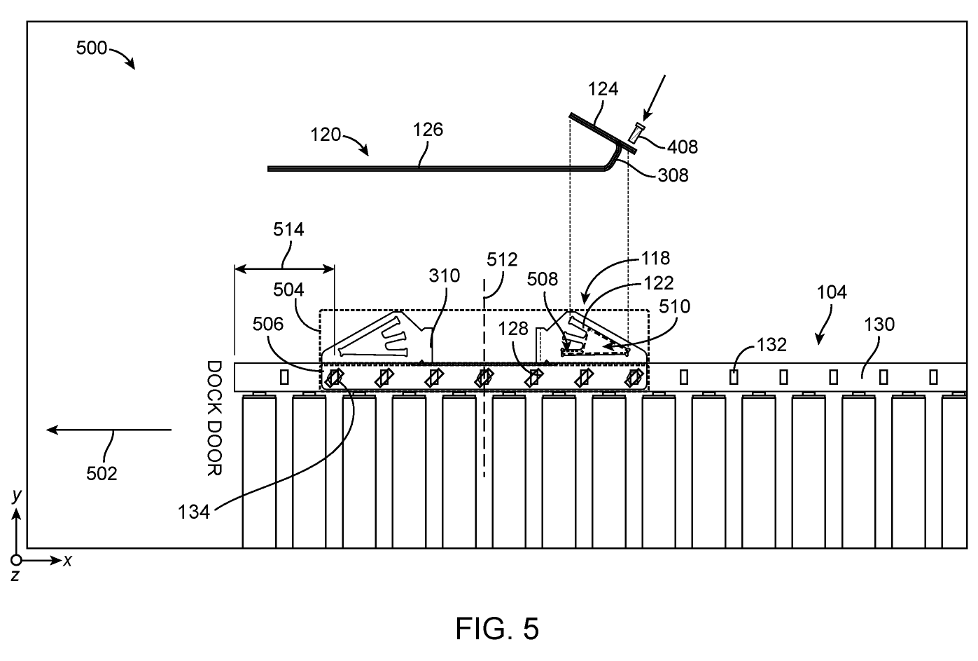

FIG. 1 shows a perspective view and a schematic top view of an example conveyance system 100 that includes an aligner device 102 for redirecting items in conveyance, in accordance with some implementations. FIG. 1 also shows a coordinate system defining x, y, and z axes. This coordinate system will be referred to throughout this disclosure, even though it is only explicitly shown in FIGS. 1 and 5.

The aligner device 102 is installed on Conveyor A 104. As indicated in the schematic top view, Conveyor B 106 is placed adjacent Conveyor A 104. As previously mentioned, conveyors are often misaligned relative to one another as there is a margin for error in the process(es) involved in their positioning/repositioning. Here, there is a lateral offset 108 (e.g., an offset in the y-axis direction) between Conveyor A 104 and Conveyor B 106. Without intervention (e.g., without the use of the aligner device 102), some items in conveyance are at risk of being inadvertently discharged from the conveyance system, causing a blockage, or otherwise unsuccessfully transitioning from Conveyor A 104 to Conveyor B 106, due to the lateral offset 108.

The aligner device 102 is installed on Conveyor A 104 so as to redirect items in conveyance to compensate for the lateral offset 108. For example, item 110 is in conveyance on Conveyor A 104. Conveyor A 104 has a general direction of conveyance indicated by arrow 112. Conveyor B 106 has a general direction of conveyance indicated by arrow 114. Arrows 116a-116c indicate a series of conveyance pathways of the item 110 that includes a redirected pathway based on the item’s 110 engagement with the aligner device 102. As indicated by initial conveyance pathway arrow 116a, were it not for its pathway being redirected (as indicated by redirected conveyance pathway arrow 116b) by the aligner device 102, the item’s 110 initial conveyance pathway 116a would put it in a trajectory to overhang a side edge of Conveyor B 106, if not fall off the conveyance system 100 in the transition from Conveyor A 104 to Conveyor B 106. As indicated by the next conveyance pathway 116c, once item 110 is on Conveyor B 106, it proceeds on a trajectory parallel to Conveyor B’s 106 general direction of conveyance 114, in a more secure lateral position than it would have been without the use of the aligner device 102.

In various implementations, the aligner device 102 includes a bracket 118 and an aligner arm 120. The bracket 118 is configured to couple with a conveyor (e.g., Conveyor A 104, in this example). The bracket 118 defines multiple slots 122 that are oriented at different angles. The aligner arm 120 includes a coupling portion 124 and a redirecting portion 126. The coupling portion 124 is configured to be inserted into a slot 122 of the bracket 118. The redirecting portion 126 extends from the coupling portion 124 and is configured to redirect items in conveyance (e.g., item 110) that engage with the redirecting portion 126 (e.g., due to a conveyance pathway of the item intersecting with the redirecting portion 126). The multiple slots 122 allow for the aligner arm 120 to be positioned at different angles, e.g., based on the amount of course correction required for a given lateral offset.

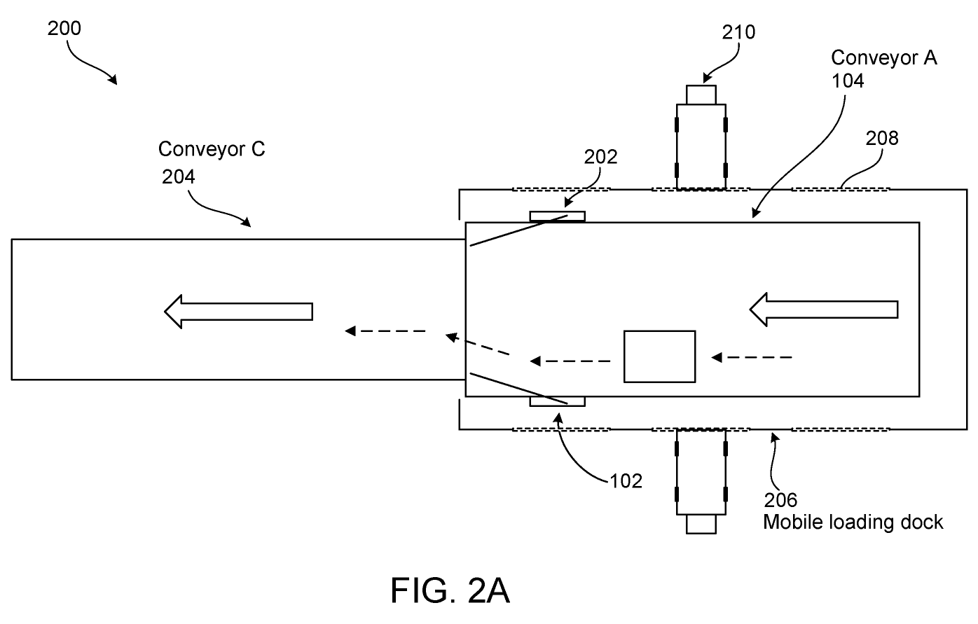

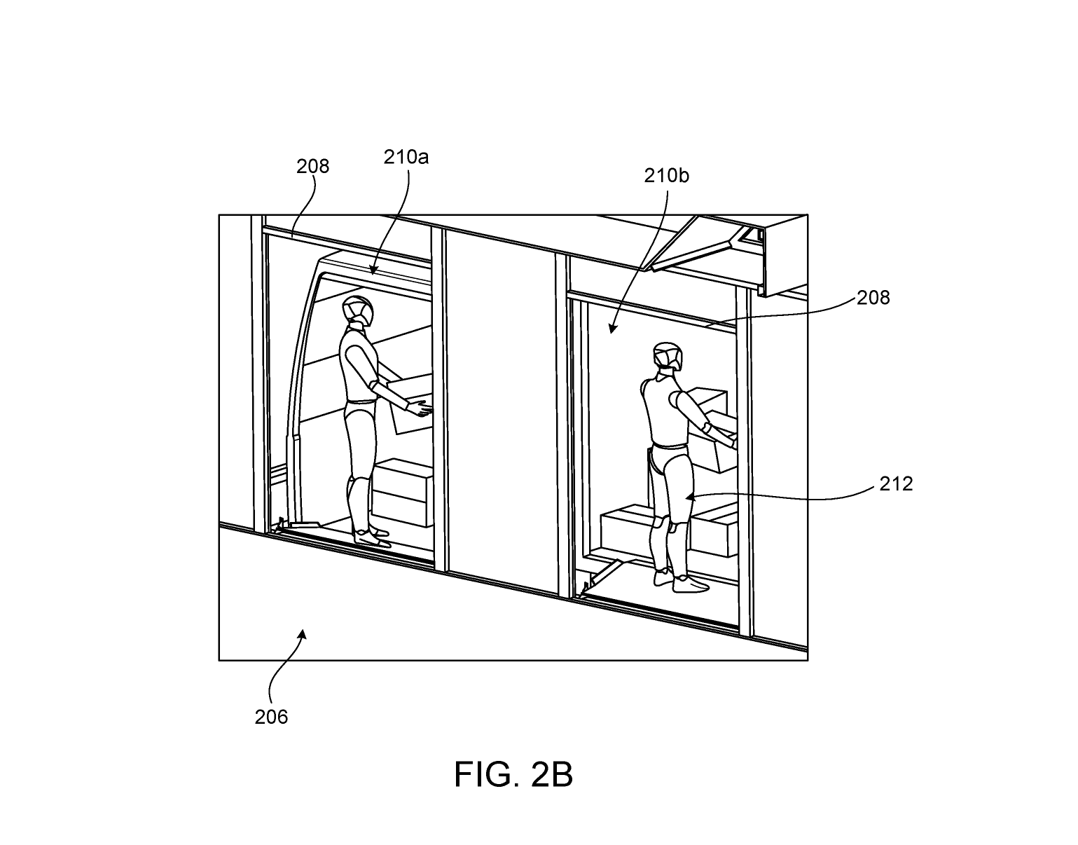

In various implementations, the bracket 118 includes an additional set of slots 128 configured to mount the bracket 118 to the conveyor. For example, Conveyor A 104 includes a conveyor frame 130 with an upper surface defining holes/slots 132. One or more of the slots 128 of the bracket 118 can be aligned with a respective hole/slot 132 of the conveyor frame 130, and a respective bolt 134 (or any other suitable fastener) can be inserted through the slot(s) 128 and the hole(s)/slot(s) 132 to attach the bracket 118 to the conveyor frame 130. Various aspects of the aligner device 102 are described in further detail herein with reference to FIGS. 2-7.

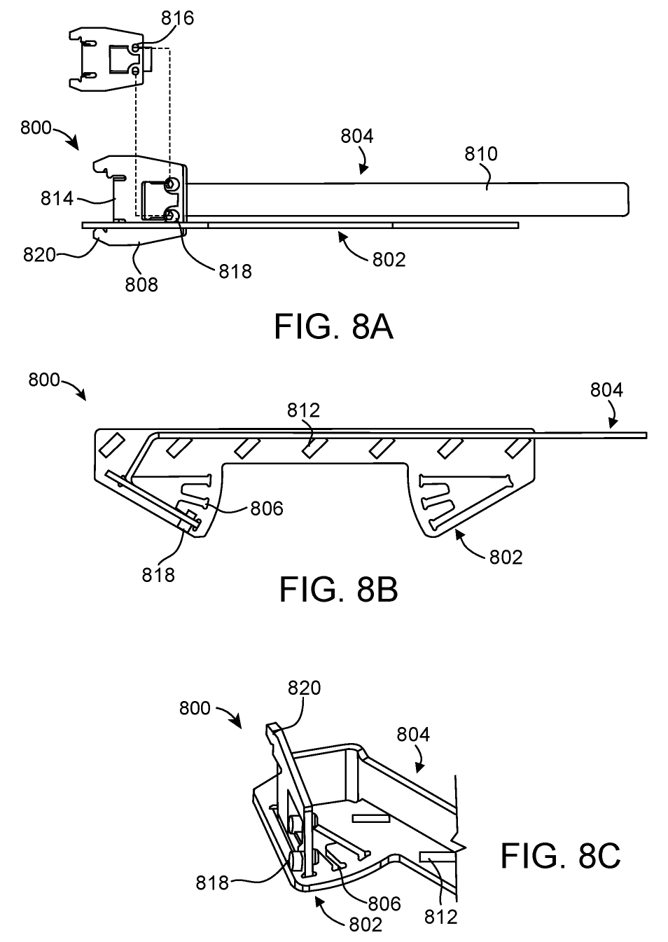

FIGS. 2A-2B are views of another example conveyance system 200 that includes one or more aligner devices (e.g., aligner device 102 in FIG. 1, aligner device 202 in FIG. 2A, and/or aligner device 800 in FIGS. 8A-8C, etc.) used in a mobile loading dock environment, in accordance with some implementations. FIG. 2A shows a schematic top view of the conveyance system 200. In the illustrated example, multiple aligner devices (e.g., a first aligner device 102 and a second aligner device 202) are installed on Conveyor A 104. Conveyor C 204 is located adjacent Conveyor A 104. As indicated in FIG. 2A, Conveyor A 104 is located within an interior portion of a mobile loading dock 206. The mobile loading dock 206 includes doors 208 that allow for access to cargo space within vehicles 210 placed next to the doors 208. In some implementations, the doors 210 are operable between open and closed positions. As an example, a door 208 is opened so that a vehicle 210 having rear cargo space can back up to the open doorway, allowing workers (e.g., people and/or robotics, etc.) inside the mobile loading dock 206 access to the rear cargo space. In the illustrated example, the aligner devices and the direction of conveyance are configured to enable the workers to unload items from the rear cargo space onto Conveyor A 104, such that the unloaded items are subsequently conveyed onto Conveyor C 204 (and then possibly one or more subsequent adjacent conveyors).

As indicated in FIG. 2A, Conveyor A 104 is wider than Conveyor C 204, e.g., with respect to a width dimension in the y-axis direction. The first aligner device 102 is installed on a first side of Conveyor A 104. The second aligner device 202 is installed on a second side of Conveyor A 104 opposite the first side. The aligner device 102 and the aligner device 202 are installed so as to redirect items in conveyance to compensate for the difference in width between Conveyor A 104 and Conveyor C 204.

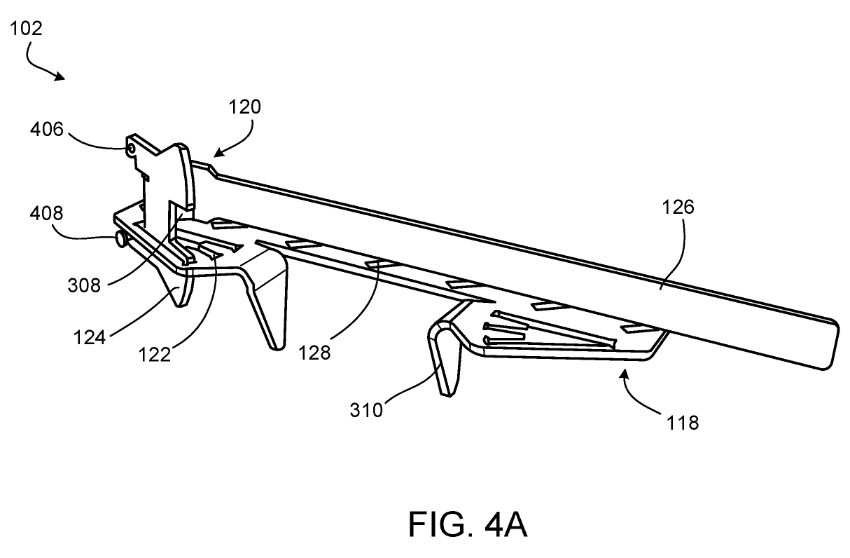

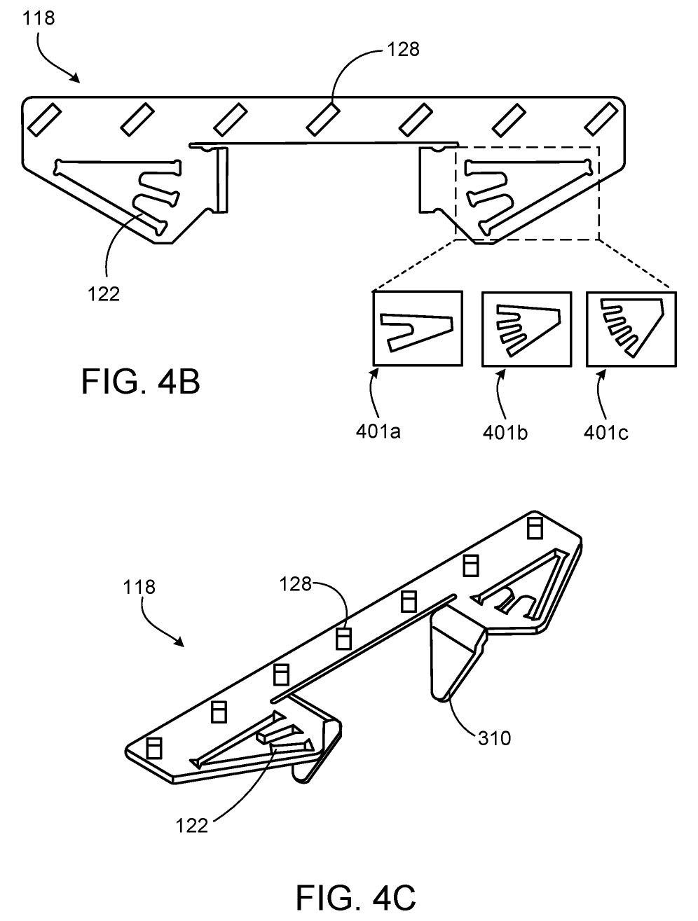

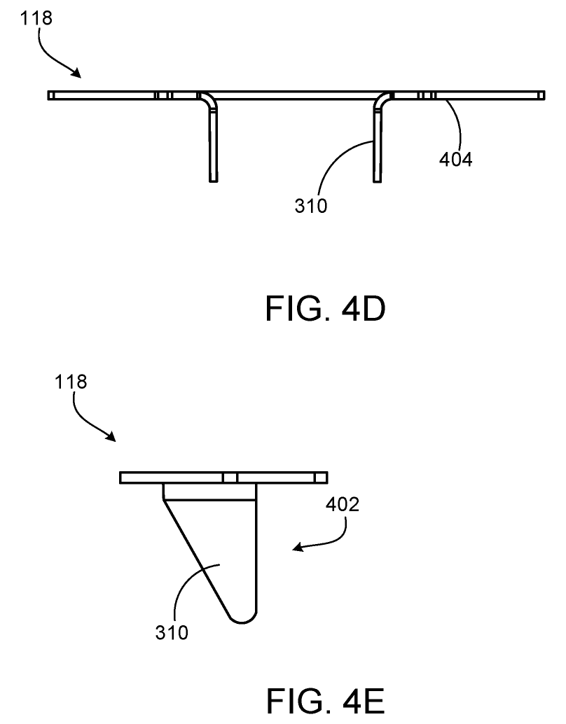

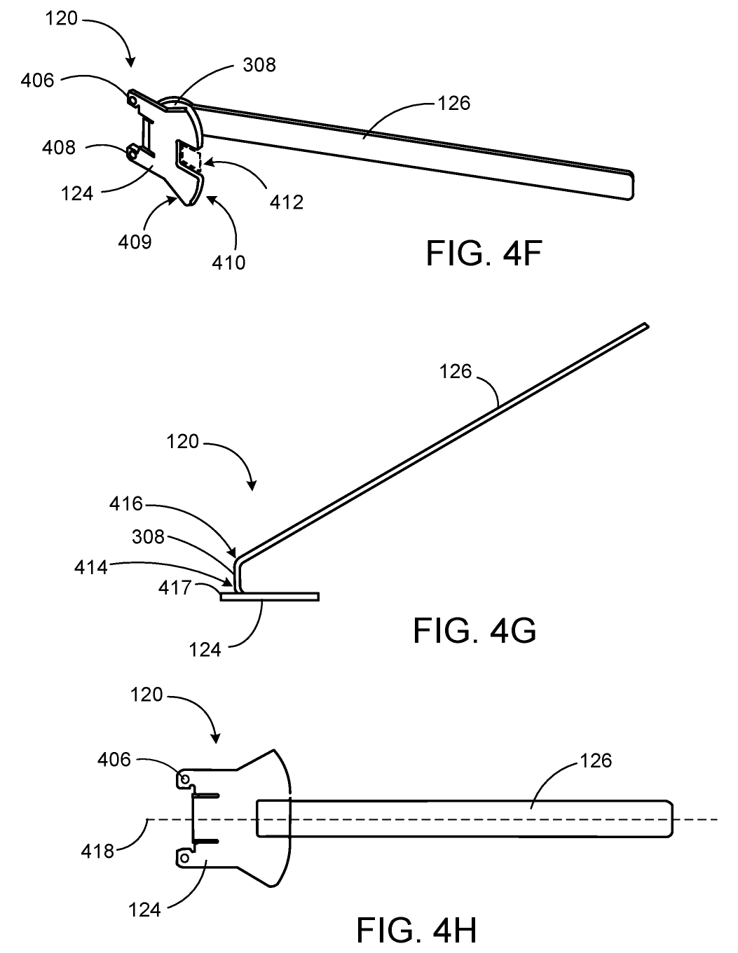

According to various implementations, the first aligner device 102 and/or the second aligner device 202 have symmetrical features, facilitating easy installation and adjustment in different configurations to suit system parameters. In some implementations, the symmetry can allow the aligner device to be mounted on either side of a conveyor. As a non-limiting example, the first aligner device 102 and the second aligner device 202 can have the same design and be installed on opposite sides of Conveyor A 104. Additionally, or alternatively, the symmetry can allow the aligner device to accommodate different conveyance directions. Examples of symmetrical features of the aligner device are discussed herein with reference to at least FIGS. 4A-5.

FIG. 2B shows a perspective view of an example interior portion of the mobile loading dock 206. Workers 212 are unloading items from vehicles 210a and 210b. In the illustrated example, vehicle 210a and vehicle 210b are different types of vehicles. For instance, vehicle 210a is a type of van, and vehicle 210b is a type of truck. However, some or all of the vehicles 210 can be of the same type in various implementations. The doors 208 are open to allow the workers 212 to transfer items from the vehicles 210 to Conveyor A 104. In some implementations, when access to a vehicle 210 via one or more of the doors 208 is not required, those doors 208 can be closed, if desired. In other implementations, the aligner devices and the direction of conveyance can be configured to allow workers to load items from the mobile loading dock 206 into one or more vehicles 210. For example, items conveyed to Conveyor A 104 can be transferred from Conveyor A 104 to a cargo space of a vehicle 210, with an open door 208 allowing workers to maneuver between the interior portion of the mobile loading dock 206 and the cargo space that is external to the mobile loading dock 206.

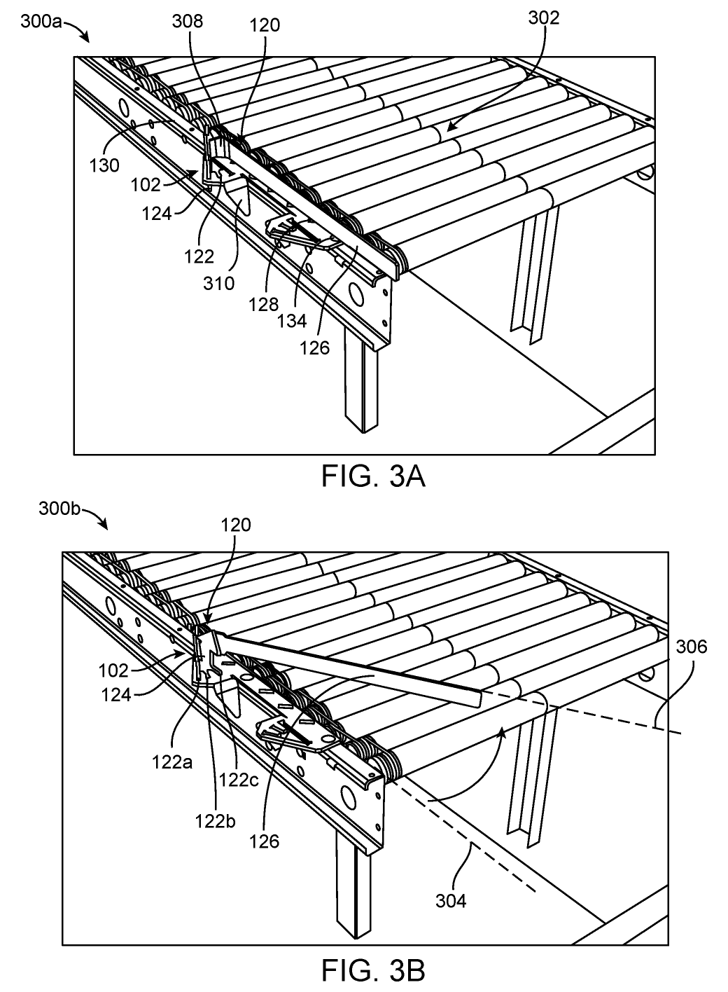

FIGS. 3A-3B are perspective views illustrating example aligner arm positions 300 of an aligner device (e.g., aligner device 102 in FIG. 1 and/or aligner device 800 in FIGS. 8A-8C, etc.) installed on a conveyor, in accordance with some implementations. FIG. 3A shows the aligner device with its aligner arm in a first position 300a (e.g., a nonuse position). FIG. 3B shows the aligner device with its aligner arm in a second position 300b (e.g., an in-use position).

In the illustrated examples, the aligner device 102 is installed on a conveyor 302. As previously mentioned, the bracket 118 of the aligner arm device 102 defines multiple slots 122 that are oriented at different angles. The aligner arm 120 includes a coupling portion 124 configured to be inserted into a slot 122 of the bracket 118. The redirecting portion 126 of the aligner arm 120 extends from the coupling portion 124 and is configured to redirect items in conveyance (e.g., item 110 in FIG. 1) that engage with the redirecting portion 126. The multiple slots 122 allow for the aligner arm 120 to be positioned at different angles, e.g., based on the amount of course correction required to maintain items within a desired range of conveyance pathways.

As indicated in FIG. 3A, which shows the first aligner arm position 300a, the aligner arm 120 is coupled with the bracket 118 such that the aligner arm 120 is positioned to not engage with items in conveyance. In this example, the aligner arm 120 does not overlap (e.g., in directions parallel to the x-y plane) with a conveyance surface/portion (e.g., the surface/portion on which items would be placed for conveyance) of the conveyor 302 and thus does not interfere with potential conveyance pathways. In various examples, the aligner arm 120 is placed in the first aligner arm position 300a when it is not being used to redirect items in conveyance. Accordingly, the first aligner arm position 300a can also be called a nonuse position.

As indicated in FIG. 3B, which shows the second aligner arm position 300b, the aligner arm 120 is coupled with the bracket 118 such that the aligner arm 120 is positioned to overlap (e.g., in directions parallel to the x-y plane) with the conveyance surface/portion of the conveyor 302 and thus potentially engage with items in conveyance (e.g., those with conveyance pathways that intersect the redirecting portion 126 of the aligner arm 120). The aligner arm 120 can be placed in the second aligner arm position 300b (or a different position that overlaps the conveyance surface/portion of the conveyor 302) when it is being used to redirect items in conveyance. Accordingly, the second aligner arm position 300b can also be called an in-use position.

FIG. 3B shows example slots 122a-122c. Each of the slots 122a-122c corresponds to a different position in which the aligner arm 120 can be placed. For example, the coupling portion 124 of the aligner arm 120 is inserted into slot 122a to place the aligner arm 120 in the first aligner arm position 300a. The direction in which the redirecting portion 126 extends when in the first aligner arm position 300a is generally indicated by dashed line 304. To place the aligner arm 120 in the second aligner arm position 300b, the coupling portion 124 is inserted into slot 122c. The direction in which the redirecting portion 126 extends when in the second aligner arm position 300b is generally indicated by dashed line 306. Slot 122b corresponds to an intermediate aligner arm position between the first aligner arm position 300a and the second aligner arm position 300b. The intermediate aligner arm position can be another in-use position. In some implementations, the bracket 118 can define fewer or more slots 122 (e.g., to accommodate a different number of discrete aligner arm positions) in other implementations.

According to various implementations, the aligner arm 120 includes an interconnecting portion 308 (FIG. 3A) that extends between the coupling portion 124 and the redirecting portion 126. The interconnecting portion 308 can be curved or otherwise shaped to position the redirecting portion 126 at a nonzero angle relative to the coupling portion 124. In some implementations, some or all of the portions of the aligner arm 120 can be integrally formed. For example, a single piece of material (e.g., a sheet of metal) can be cut, bent, shaped, and/or otherwise manipulated via one or more manufacturing processes to create the final shape of the aligner arm 120 that is to be used in the aligner device 102. In some implementations, portions of the aligner arm 120 can be fixedly coupled with one another (e.g., via welds, fasteners, and/or adhesives, etc.) to form the final shape of the aligner arm 120. The interconnecting portion 308 and/or other aspects of the aligner arm 120 are also discussed herein with reference to FIGS. 4A-7.

In some implementations, the bracket 118 includes a support flange 310 (FIG. 3A) having at least one surface configured to engage a side surface of the conveyor frame 130. For example, as indicated in FIGS. 3A-3B, the support flange 310 extends vertically downward (e.g., in the z-axis direction) so as to abut a side surface of the conveyor frame 130. In some implementations, the support flange 310 includes a surface that is flush with the side surface of the conveyor frame 130 such that the surfaces are in contact over a surface area (e.g., extending in directions parallel to the x-z plane). The support flange 310 and/or other aspects of the bracket 118 are also discussed herein with reference to FIGS. 4A-7.

FIGS. 4A-4H are views of an example aligner device (e.g., aligner device 102) for redirecting items in conveyance, in accordance with some implementations. FIG. 4A shows a perspective view of the aligner device 102. FIG. 4B shows a top view of a bracket 118 of the aligner device 102. FIG. 4C shows a perspective view of the bracket 118. FIG. 4D shows a front view of the bracket. FIG. 4E shows a side view of the bracket 118. FIG. 4F shows a perspective view of an aligner arm 120 of the aligner device 102. FIG. 4G shows a top view of the aligner arm 120. FIG. 4H shows a front view of the aligner arm 120.

In various implementations, the aligner device 102 includes a bracket 118 and an aligner arm 120. The bracket 118 is configured to couple with a conveyor (e.g., Conveyor A 104 in FIG. 1). The bracket 118 defines multiple slots 122 that are oriented at different angles. The aligner arm 120 includes a coupling portion 124 and a redirecting portion 126. The coupling portion 124 is configured to be inserted into a slot 122 (of the multiple slots 122 defined by the bracket 118) to couple the aligner arm 120 with the bracket 118. The redirecting portion 126 extends from the coupling portion 124 (e.g., via the interconnecting portion 308) and is configured to redirect items in conveyance (e.g., item 110 in FIG. 1) that engage with the redirecting portion 126.

According to various implementations, the slots 122 defined by the bracket 118 include a first slot (e.g., slot 122a in FIG. 3B), a second slot (e.g., slot 122b in FIG. 3B), and/or a third slot (e.g., slot 122c in FIG. 3C). The first slot 122a is configured to couple the bracket 118 with the coupling portion 124 of the aligner arm 120 so as to orient the redirecting portion 126 of the aligner arm 120 in a first position (e.g., the nonuse position described herein with reference to FIG. 3A). In some implementations, the first slot 122a is used to orient the redirecting portion of the aligner arm 120 parallel to a direction of conveyance. The second slot 122b is configured to couple the bracket 118 with the coupling portion 124 so as to orient the redirecting portion 126 at a first nonzero angle relative to the direction of conveyance. The third slot 122c is configured to couple the bracket 118 with the coupling portion 124 so as to orient the redirecting portion 126 at a second nonzero angle, relative to the direction of conveyance, different than the first nonzero angle. The first nonzero angle and/or the second nonzero angle can be in-use positions, as discussed herein with reference to FIG. 3B. In other implementations, the bracket 118 can define fewer or more slots 122, e.g., to accommodate a different number of discrete aligner arm positions. As non-limiting examples, FIG. 4B shows alternative configurations 401a-401c in which different numbers of slots are included, in accordance with some implementations. Alternative configuration 401a is an example in which the bracket 118 defines two slots. Alternative configuration 401b is an example in which the bracket 118 defines four slots. Alternative configuration 401c is an example in which the bracket 118 defines five slots.

The bracket defines an additional set of slots 128 configured to mount the bracket 118 to the conveyor. For example, as discussed with reference to FIG. 1, Conveyor A 104 includes a conveyor frame 130 with an upper surface defining holes/slots 132. One or more of the slots 128 of the bracket 118 can be aligned with a respective hole/slot 132 of the conveyor frame 130, and a respective bolt 134 (or any other suitable fastener) can be inserted through the slot(s) 128 and the hole(s)/slot(s) 132 to attach the bracket 118 to the conveyor frame 130.

In some implementations, the bracket 118 includes a support flange 310 (FIG. 3A) having at least one surface 402 (FIG. 4E) configured to engage a side surface of the conveyor frame 130. For example, as indicated in FIGS. 3A-3B, the support flange 310 extends vertically downward (e.g., in the z-axis direction) so as to abut a side surface of the conveyor frame 130. The support flange 310 can be used to enhance stability of the aligner device 102 by countering moment forces acting on the aligner device 102, such as those imposed due to items in conveyance engaging with the aligner arm 120. In some implementations, the surface 402 is flush with the side surface of the conveyor frame 130 such that the surfaces are in contact over a surface area (e.g., extending in directions parallel to the x-z plane). According to some implementations, the support flange 310 is formed by bending down a portion of the bracket 118. For example, as indicated in FIG. 4D, the bracket 118 includes bend 404. In a non-limiting example, the bend 404 has a bend angle of 90 degrees and a centerline radius of 0.375 inches.

In some implementations, the redirecting portion 126 of the aligner arm 120 includes a planar surface (e.g., in FIG. 4H, the surface of the redirecting portion 126 facing the viewer) providing a contact surface area configured to engage with items in a conveyance pathway that intersects with the planar surface. The coupling portion 124 of the aligner arm 120 includes a planar surface (e.g., in FIG. 4H, the surface of the coupling portion 124 facing the viewer) oriented at a nonzero angle to the planar surface of the redirecting portion 126. The planar surface of the redirecting portion 126 is stationary relative to the planar surface of the coupling portion 124. According to some implementations, the aligner arm 120 includes an interconnecting portion 308 that extends between the coupling portion 124 and the redirecting portion 126. The interconnecting portion 308 is shaped to orient the planar surface of the redirecting portion 126 at the nonzero angle relative to the planar surface of the coupling portion 124. For example, the interconnecting portion 308 can include a curved surface that interconnects the planar surface of the redirecting portion 126 with the planar surface of the coupling portion 124.

The bracket 118 includes a planar surface that at least partially defines the slots 122. When the aligner arm 120 is coupled with the bracket 118 via the coupling portion 124, the planar surface of the bracket 118 is orthogonal to the planar surface of the coupling portion 124 and the planar surface of the redirecting portion 126.

In various implementations, the coupling portion 124 of the aligner arm 120 defines one or more apertures 406 configured to receive a fastener 408. The coupling portion 124 can be inserted into a slot 122 such that an aperture 406 is positioned below the slot 122. The fastener 408 can be inserted into the aperture 406 positioned below the slot 122, e.g., as indicated in FIG. 4A. In some implementations, one or more portions of the bracket 118 and/or the aligner arm 120 contribute toward maintaining the aligner arm in a fixed position relative to the bracket 118 while installed. For example, the slot 122, the coupling portion 124, the fastener 408 (when inserted into the aperture 406), and/or an underside of the interconnecting portion 308 (when engaging the bracket 118) can restrict one or more degrees of freedom of the aligner arm 120.

As indicated in FIG. 4F, the coupling portion 124 includes one or more other features whose shapes can contribute toward coupling the aligner arm 120 with the bracket 118. For example, the coupling portion 124 includes tapered and/or curved surfaces 409 and 410 forming at least a portion of a tab configured to be inserted into a slot 122. The slots 122 can be sized to receive such a tab and restrict or prevent motion of the aligner arm 120 in multiple degrees of freedom (e.g., in directions along the x-y plane). In various implementations, the coupling portion 124 includes two tabs with a cut-out section 412 between the tabs. For example, the cut-out section 412 can demarcate a separation between the tabs in the z-axis direction, with the tabs connecting at an inner surface that partially defines the cut-out section 412.

As indicated in FIG. 4G, the aligner arm 120 includes one or more bends (e.g., in the interconnecting portion 308), such as a first bend 414 and a second bend 416. As a non-limiting example, the first bend 414 has a bend angle of 90 degrees and a centerline radius of 0.5 inches, and the second bend 416 has a bend angle of 60 degrees and a centerline radius of 0.5 inches.

In various embodiments, the aligner arm 120 includes symmetrical features. For example, the aligner arm 120 can have mirror symmetry about a plane 418 (FIG. 4H) parallel to the x-y plane.

FIG. 5 is a top view of an example system 500 that includes an aligner device (e.g., aligner device 102) for redirecting items in conveyance, in accordance with some implementations. The bracket 118 of the aligner device 102 is mounted on a conveyor (e.g., Conveyor A 104, also referred to here as conveyor 104). In the illustrated example, arrow 502 indicates a direction of conveyance toward a dock door. The conveyor 104 includes a conveyor frame 130. The conveyor frame 130 includes a mounting surface that is parallel to a direction of conveyance and that defines holes 132 and/or parallel to the x-y plane.

A first section 504 of the bracket 118 defines the multiple slots 122. A second section 506 of the bracket 118 defines the additional slots 128. One or more of the additional slots 128 are in sufficient alignment with one or more holes 132 defined by the mounting surface of the conveyor frame 130 to receive one or more fasteners 134 that couple the bracket 118 with the conveyor 104. The first section 504 comprises a first upper surface. The second section 506 comprises a second upper surface that is parallel to the first upper surface. In some implementations, a same surface of the bracket 118 defines the multiple slots 122 and the additional slots 128.

In some implementations, the additional slots 128 are oriented at a same angle relative to one another. It should be understood, however, that one or more of the additional slots 128 can be oriented at a different angle relative to one or more other ones of the additional slots 128 in various embodiments. The additional slots 128 are closer to the conveyor 104 than the multiple slots 122. When viewed in plan, the second section 506 at least partially overlaps with the conveyor 104 and the first section 504 does not overlap with the conveyor 104, in accordance with some implementations.

The mounting surface is an upper surface of the conveyor frame 130, such as the surface of the conveyor frame 130 that at least partially defines the holes/slots 132 and that faces the viewer in FIG. 5. The conveyor frame 130 further comprises a side surface extending downward from the upper surface toward a floor supporting the conveyor 104. As also described herein with reference to at least FIGS. 3A-4H, the bracket 118 includes a support flange 310 comprising at least one surface that engages the side surface of the conveyor frame 130.

According to some implementations, each of the multiple slots 122 includes a respective first portion 508 and a shared second portion 510, e.g., as indicated in FIG. 5. The respective first portion 508 of a respective slot 122 can be cut-out sections that are spaced apart, and oriented at a nonzero angle to, the respective first portion(s) 508 of one or more other slots 122. The shared second portion 510 can be a cut-out section that is common to some or all of the slots 122. In the illustrated example, each of the respective first portions 508 converge to the shared second portion 510 and share a common vertex formed as part of the shared second portion 510.

In various implementations, the bracket 118 is configured to be installed on the conveyor 104 such that the bracket 118 has a longest dimension along an axis that is parallel to a direction of conveyance (e.g., the direction indicated by arrow 502) and/or parallel to the x-axis direction. According to various implementations, the bracket 118 includes symmetrical features. For example, the bracket 118 can have mirror symmetry about a plane 512 that is parallel to the y-z plane. Additionally, or alternatively, the plane 512 of symmetry is orthogonal to, and bisects, the longest dimension of the bracket 118.

The bracket 118 extends, in the longest dimension, from a first end to a second end. The multiple slots 122 include a first set of slots 122 located proximate the first end. Furthermore, the bracket 118 defines a second set of slots 122 located proximate the second end. Each of the second set of slots 122 are oriented at a respectively different angle.

When the coupling portion 124 of the aligner arm 120 is inserted into any one of the first set of slots 122 (e.g., the slots 122 closest to the rightmost side of the bracket 118 in FIG. 5), the redirecting portion 126 of the aligner arm 120 extends from the coupling portion 124 toward a first direction of conveyance (e.g., the direction indicated by arrow 502). When the coupling portion 124 is inserted into any one of the second set of slots 122 (e.g., the slots 122 closest to the leftmost side of the bracket 118 in FIG. 5), the redirecting portion 126 of the aligner arm120 extends from the coupling portion 124 toward a second direction of conveyance that is opposite the first direction of conveyance.

The first set of slots 122 share a first common vertex from which they fan out to form different angles. The first common vertex is the closest portion of the first set of slots 122 to the first end of the bracket 118. The second set of slots 122 share a common vertex from which they fan out to form different angles. The second common vertex is the closest portion of the second set of slots to the second end of the bracket 118.

In FIG. 5, dimension 514 represents an example distance between a portion of the bracket 118 and an end of the conveyor 104. For example, the dimension 514 can indicate a distance between a closest bracket-conveyor frame hole/slot alignment and an end of the conveyor 104. The closest bracket-conveyor frame hole/slot alignment corresponds to the additional slot 128 of the bracket 118 that is aligned with a hole/slot 132 of the conveyor frame 130 and that is closest to the end of the conveyor 104 relative to other bracket-conveyor frame hole/slot alignments. In a non-limiting example, the dimension 514 is a distance, in the x-axis direction, of six inches. According to some implementations, multiple aligner devices are mounted at increments (e.g., along the x-axis direction) to provide multiple alignment points on the same side of a conveyor. In a non-limiting example, two aligner devices are installed on the same side of a conveyor. A first aligner device is installed as shown in FIG. 5, e.g., with the dimension 514 being six inches. A second aligner device (not shown) is installed such that its centerline is spaced 240 inches apart from the first aligner device’s centerline. The dashed line representing plane 512 also represents an example centerline of an aligner device for the purposes of this example.

Due to the symmetrical features previously described, the aligner device 102 can be installed on either side of the conveyor 104 in some implementations. The aligner arm 120 can be coupled with any of the first set of slots 21 or with any of the second set of slots 122 to easily adjust for a different side of the conveyor 104 or to accommodate a different direction of conveyance.

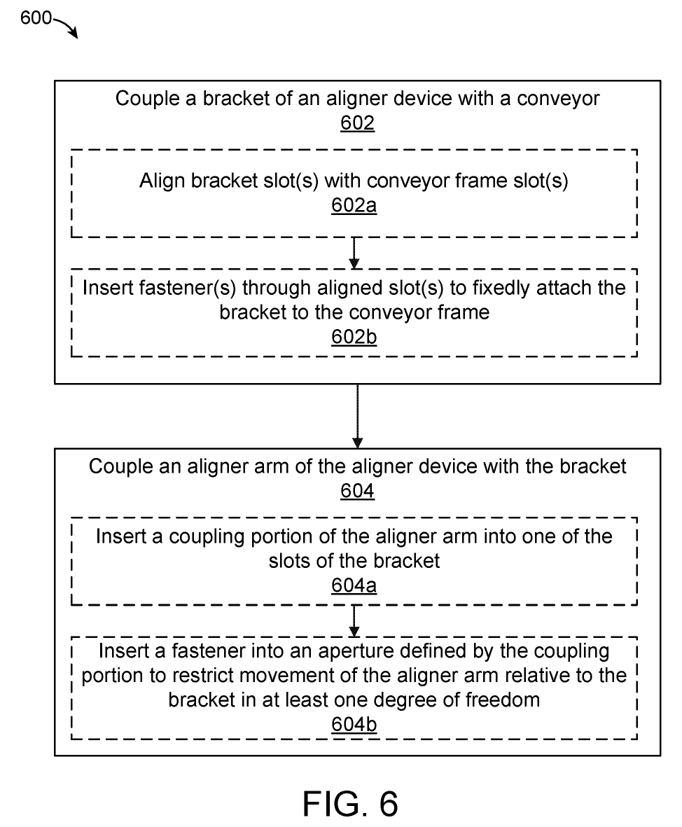

FIG. 6 is a flow chart illustrating an example method 600 of installing an aligner device (e.g., aligner device 102 in FIG. 1 and/or aligner device 800 in FIGS. 8A-8C, etc.), in accordance with some implementations.

At 602, the method 600 includes coupling a bracket (e.g., bracket 118 in FIG. 1) of the aligner device with a conveyor (e.g., Conveyor A 104 in FIG. 1). At 604, the method 600 includes coupling an aligner arm (e.g., aligner arm 120 in FIG. 1) of the aligner device with the bracket.

In some examples, coupling the bracket with the conveyor (at 602) includes aligning one or more slots (e.g., slots 122 in FIG. 1) of the bracket with one or more holes (e.g., holes/slots 132 in FIG. 1) of a conveyor frame (e.g., conveyor frame 130 in FIG. 1), at 602a. Furthermore, in some examples, coupling the bracket with the conveyor (at 602) includes inserting one or more fasteners (e.g., fasteners 134 in FIG. 1) through at least a portion of the slot(s) and the hole(s) that are aligned, to attach the bracket to the conveyor frame, at 602b.

According to some examples, coupling the aligner arm with the bracket (at 604) includes inserting a coupling portion (e.g., coupling portion 124 in FIG. 1) of the aligner arm into one of the slots of the bracket, at 604a. Furthermore, in some examples, coupling the aligner arm with the bracket includes inserting a fastener (e.g., fastener 408 in FIG. 4A and/or fastener 818 in FIGS. 8A-8C, etc.) into an aperture (e.g., aperture 406 in FIG. 4A and/or aperture 816 in FIG. 8A, etc.) defined by the coupling portion, e.g., to restrict movement of the aligner arm relative to the bracket, in at least one degree of freedom, at 604b. Additionally, or alternatively, a surface of the fastener provides compressive contact with the aperture to keep the aligner arm in a fixed position regardless of a direction of impact on the aligner arm by external forces (e.g., items in conveyance).

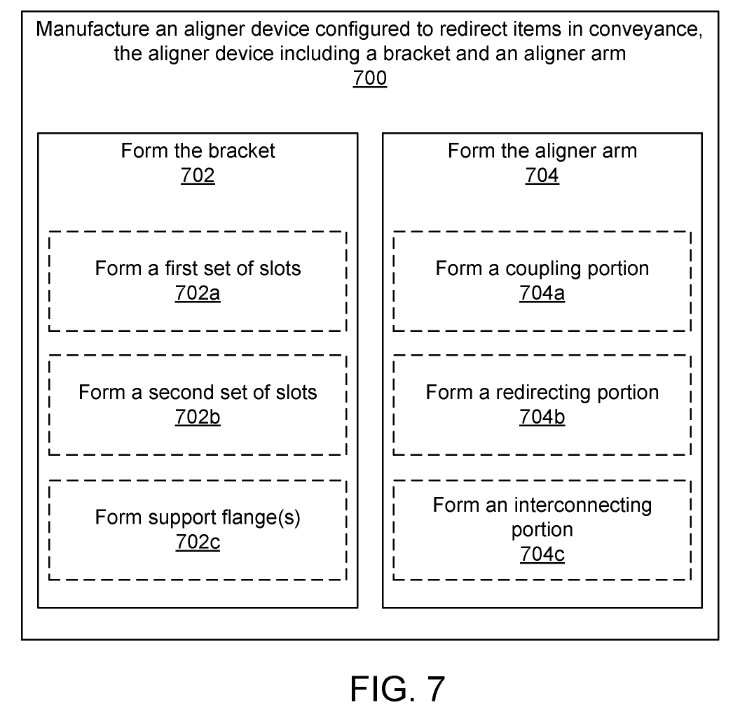

FIG. 7 is a flow chart illustrating an example method 700 of manufacturing an aligner device (e.g., aligner device 102 in FIG. 1 and/or aligner device 800 in FIGS. 8A-8C), in accordance with some implementations.

At 702, the method 700 includes forming a bracket (e.g., bracket 118 in FIG. 1) of the aligner device. In some examples, forming the bracket (at 702) includes forming a first set of slots (at 702a) (e.g., multiple slots 122 in FIG. 1), forming a second set of slots (at 702b) (e.g., additional slots 128 in FIG. 1), and/or forming one or more support flanges (at 702c) (e.g., support flange 310 in FIGS. 3A-3B). FIGS. 4B-4E show views of bracket 118, including the previously mentioned features, according to some non-limiting examples.

At 704, the method 700 includes forming an aligner arm (e.g., aligner arm 120 in FIG. 1) of the aligner device. In some examples, forming the aligner arm includes forming a coupling portion (at 704a) (e.g., coupling portion 124 in FIG. 1), forming a redirecting portion (at 704b) (e.g., redirecting portion 126 in FIG. 1), and/or forming an interconnecting portion (at 704c) (e.g., interconnecting portion 308 in FIGS. 3A-3B). FIGS. 4F-4H show views of aligner arm 120, including the previously mentioned features, according to some non-limiting examples.

In some non-limiting examples, the bracket and/or the aligner arm are formed using coldworking metal fabrication materials, equipment, and/or processes. For example, the bracket and/or the aligner arm can be formed from sheet metal that is cut (e.g., via one or more laser cutters, etc.) and further shaped (e.g., via one or more press brakes, etc.) into its final form.

FIGS. 8A-8C are views of another example aligner device 800 for redirecting items in conveyance, in accordance with some implementations. FIG. 8A shows a front view of the aligner device 800. FIG. 8B shows a top view of the aligner device 800. FIG. 8C shows a detailed perspective view of a portion of the aligner device 800. In some implementations, the aligner device 800 can include one or more aspects of the aligner devices described above (e.g., aligner device 102 in FIG. 1), and vice versa.

In various implementations, the aligner device 800 includes a bracket 802 (e.g., having one or more aspects similar to bracket 118 in FIG. 1) and an aligner arm 804 (e.g., having one or more aspects similar to aligner arm 120 in FIG. 1). The bracket 802 is configured to couple with a conveyor (e.g., Conveyor A 104 in FIG. 1). The bracket 802 defines multiple slots 806 that are oriented at different angles. The aligner arm 804 includes a coupling portion 808 and a redirecting portion 810. The coupling portion 808 is configured to be inserted into a slot 806 of the bracket 802. The redirecting portion 810 extends from the coupling portion 808 and is configured to redirect items in conveyance (e.g., item 110 in FIG. 1) that engage with the redirecting portion 810 (e.g., due to a conveyance pathway of the item intersecting with the redirecting portion 810). The multiple slots 806 allow for the aligner arm 804 to be positioned at different angles, e.g., based on the amount of course correction required for items in conveyance.

In various implementations, the bracket 802 includes an additional set of slots 812 configured to mount the bracket 802 to the conveyor. For example, Conveyor A 104 in FIG. 1 includes a conveyor frame 130 with an upper surface defining holes/slots 132. One or more of the slots 812 of the bracket 802 can be aligned with a respective hole/slot 132 of the conveyor frame 130, and a respective bolt (or any other suitable fastener) can be inserted through the slot(s) 812 and the hole(s)/slot(s) 132 to attach the bracket 802 to the conveyor frame 130.

According to some implementations, the aligner arm 804 includes an interconnecting portion 814 that extends between the coupling portion 808 and the redirecting portion 810. The interconnecting portion 814 can be curved or otherwise shaped to position the redirecting portion 810 at a nonzero angle relative to the coupling portion 808.

In some implementations, the coupling portion 808 of the aligner arm 804 defines one or more apertures 816 each configured to receive a fastener 818 or the like. The coupling portion 808 can be inserted into a slot 806 such that an aperture 816 is positioned above the slot 806. The fastener 818 can be inserted into the aperture 816 positioned above the slot 806, e.g., as indicated in FIGS. 8A-8C. Additionally, or alternatively, the coupling portion 808 of the aligner arm 804 defines one or more protrusions 820. The coupling portion 808 can be inserted into a slot 806 such that at least one protrusion 820 is positioned below the slot 806. An upper surface of the protrusion 820 positioned below the slot 806 can engage an underside of bracket 802.

In some implementations, one or more portions of the bracket 802 and/or the aligner arm 804 contribute toward maintaining the aligner arm 804 in a fixed position relative to the bracket 802 while installed. For example, the slot 806, the coupling portion 808, the fastener 818 (when inserted into the aperture 816), and/or the protrusion(s) 820 can restrict one or more degrees of freedom of the aligner arm 804.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. Accordingly, other implementations are within the scope of the following claim(s).

1. A device, comprising:
a bracket configured to couple with a conveyor, the bracket defining multiple slots that are oriented at different angles; and
an aligner arm, comprising:
a coupling portion configured to be inserted into a slot of the multiple slots to couple the aligner arm with the bracket; and
a redirecting portion that extends from the coupling portion, the redirecting portion configured to redirect items in conveyance that engage with the redirecting portion.

2. The device of claim 1, wherein:
the redirecting portion of the aligner arm comprises a first planar surface providing a contact surface area configured to engage with items in a conveyance pathway that intersects with the first planar surface;
the bracket comprises a second planar surface at least partially defining the multiple slots; and
when the aligner arm is coupled with the bracket via the coupling portion, the first planar surface is orthogonal to the second planar surface.

3. The device of claim 1, wherein:
the redirecting portion of the aligner arm comprises a first planar surface providing a contact surface area configured to engage with items in a conveyance pathway that intersects with the first planar surface; and
the coupling portion of the aligner arm comprises a second planar surface oriented at a nonzero angle to the first planar surface.

4. The device of claim 3, wherein the aligner arm further comprises an interconnecting portion that extends between the coupling portion and the redirecting portion, wherein the interconnecting portion is shaped to orient the first planar surface of the redirecting portion at the nonzero angle relative to the second planar surface of the coupling portion.

5. The device of claim 3, wherein the first planar surface of the redirecting portion is stationary relative to the second planar surface of the coupling portion.

6. The device of claim 1, wherein the multiple slots defined by the bracket comprise:
a first slot configured to couple the bracket with the coupling portion of the aligner arm so as to orient the redirecting portion of the aligner arm parallel to a direction of conveyance; and
a second slot configured to couple the bracket with the coupling portion of the aligner arm so as to orient the redirecting portion of the aligner arm at a first nonzero angle relative to the direction of conveyance.

7. The device of claim 1, wherein:
the redirecting portion of the aligner arm comprises a first planar surface providing a contact surface area configured to engage with items in a conveyance pathway that intersects with the first surface;
the coupling portion of the aligner arm comprises a second planar surface oriented at a nonzero angle to the first planar surface, the second planar surface being stationary relative to the first planar surface, the coupling portion defining an aperture configured to receive a fastener such that the fastener contributes to restricting one or more degrees of freedom of the aligner arm while the coupling portion is coupled with the bracket;
the bracket comprises a third planar surface at least partially defining the multiple slots;
when the aligner arm is coupled with the bracket via the coupling portion, the first planar surface of the redirecting portion is orthogonal to the third planar surface of the bracket;
the aligner arm further comprises an interconnecting portion that extends between the coupling portion and the redirecting portion, the interconnecting portion comprising a curved surface configured to orient the first planar surface of the redirecting portion at the nonzero angle relative to the second planar surface of the coupling portion;
the multiple slots defined by the bracket comprise a first set of slots located proximate a first end of the bracket, the first set of slots comprising:
a first slot configured to couple the bracket with the coupling portion of the aligner arm so as to orient the redirecting portion of the aligner arm parallel to a direction of conveyance;
a second slot configured to couple the bracket with the coupling portion of the aligner arm so as to orient the redirecting portion of the aligner arm at a first nonzero angle relative to the direction of conveyance; and
a third slot configured to couple the bracket with the coupling portion of the aligner arm so as to orient the redirecting portion of the aligner arm at a second nonzero angle, relative to the direction of conveyance, different than the first nonzero angle;
wherein the first slot, the second slot, and the third slot share a common vertex;
the bracket further defines a second set of slots located proximate a second end of the bracket, each of the second set of slots being oriented at a respectively different angle;
a first section of the bracket defines the first set of slots and the second set of slots, the first section comprising a first upper surface;
a second section of the bracket defines additional slots configured to couple the bracket with a conveyor frame, the additional slots oriented at a same angle relative to one another, the second section comprising a second upper surface that is at least one of (i) parallel to the first upper surface or (ii) a same surface as the first upper surface;
the bracket further comprises one or more flanges comprising at least one surface configured to engage a side surface of the conveyor frame that extends downward, toward a floor supporting the conveyor, from an upper surface of the conveyor frame; and
the bracket has a longest dimension along an axis that is parallel to a direction of conveyance, and the bracket has mirror symmetry about a plane that is orthogonal to the axis and that bisects the longest dimension, the bracket extending, in the longest dimension, from the first end to the second end.

8. A system, comprising:
a conveyor;
a bracket coupled with the conveyor, the bracket defining multiple slots that are oriented at different angles; and
an aligner arm, comprising:
a coupling portion inserted into a slot of the multiple slots so as to couple the aligner arm with the bracket; and
a redirecting portion that extends from the coupling portion, the redirecting portion configured to redirect items in conveyance that engage with the redirecting portion.

9. The system of claim 8, wherein:
the conveyor comprises a conveyor frame, the conveyor frame comprising a mounting surface that is parallel to a direction of conveyance and that defines holes;
a first section of the bracket defines the multiple slots; and
a second section of the bracket defines additional slots, one or more of the additional slots being in sufficient alignment with one or more of the holes defined by the mounting surface of the conveyor frame to receive one or more fasteners that couple the bracket with the conveyor.

10. The system of claim 9, wherein:
the first section of the bracket defining the multiple slots comprises a first upper surface; and
the second section of the bracket defining the additional slots comprises a second upper surface that is parallel to the first upper surface.

11. The system of claim 9, wherein a same surface of the bracket defines the multiple slots and the additional slots.

12. The system of claim 9, wherein the additional slots are oriented at a same angle relative to one another, and wherein the additional slots are closer to the conveyor than the multiple slots.

13. The system of claim 9, wherein, when viewed in plan, the second section at least partially overlaps with the conveyor and the first section does not overlap with the conveyor.

14. The system of claim 9, wherein:
the mounting surface is an upper surface of the conveyor frame;
the conveyor frame further comprises a side surface extending downward from the upper surface toward a floor supporting the conveyor; and
the bracket further comprises a flange comprising at least one surface that engages the side surface of the conveyor frame.

15. The system of claim 8, wherein the multiple slots share a common vertex.

16. The system of claim 8, wherein the bracket has a longest dimension along an axis that is parallel to a direction of conveyance, and the bracket has mirror symmetry about a plane that is orthogonal to the axis and that bisects the longest dimension.

17. The system of claim 16, wherein:
the bracket extends, in the longest dimension, from a first end to a second end;
the multiple slots comprise a first set of slots located proximate the first end; and
the bracket further defines a second set of slots located proximate the second end, each of the second set of slots being oriented at a respectively different angle.

18. The system of claim 17, wherein:
when the coupling portion of the aligner arm is inserted into any one of the first set of slots, the redirecting portion of the aligner arm extends from the coupling portion toward a first direction of conveyance; and
when the coupling portion is inserted into any one of the second set of slots, the redirecting portion of the aligner arm extends from the coupling portion toward a second direction of conveyance that is opposite the first direction of conveyance.

19. The system of claim 17, wherein:
the first set of slots share a first common vertex from which they fan out to form the different angles, the first common vertex being the closest portion of the first set of slots to the first end; and
the second set of slots share a second common vertex from which they fan out to form the different angles, the second common vertex being the closest portion of the second set of slots to the second end.

20. A method, comprising:
coupling a bracket of an aligner device with a conveyor, the bracket defining multiple slots that are oriented at different angles; and
inserting a coupling portion of an aligner arm of the aligner device into a slot of the multiple slots of the bracket to couple the aligner arm with the bracket, the aligner arm comprising a redirecting portion that extends from the coupling portion so as to redirect items in conveyance that engage with the redirecting portion.
